(19) United States
(12) Patent Application Publication
(10) Pub. No.: US 2014/0229140 A1
(43) Pub. Date: Aug. 14, 2014

(54) COMPUTERIZED METHOD AND SYSTEM FOR LIGHT PERFORMANCE GRADING OF GEMSTONES BY ONE SINGLE GRADING SCALE

(71) Applicant: Sarine Color Technologies Ltd., Kfar Saba (IL)

(72) Inventors: Uzi LEVAMI, Hod Hasharon (IL); Akiva CASPI, Nirit (IL)

(73) Assignee: Sarine Color Technologies Ltd., Kfar Saba (IL)

(21) Appl. No.: 14/024,314

(22) Filed: Sep. 11, 2013

Related U.S. Application Data
(60) Provisional application No. 61/763,342, filed on Feb. 11, 2013.

(51) Int. Cl. G01N 21/87

(52) U.S. Cl. CPC G01N 21/87
USPC 702/179

(57) ABSTRACT

There are provided computerized methods and systems of producing a single grading scale, and for using it, for grading gemstones such as diamonds based on pre-defined parameters thereof, wherein each single grade in the scale is associated with unique groups of unique value ranges of the parameters in a statistically relevant sample of gemstones, the unique groups being established at least based on an aimed statistic distribution of gemstones through the grades in the grading scale. There is also provided a gemstone grading report comprising indication of a grade for the gemstone in the single grading.

### CROSS-REFERENCE TO RELATED APPLICATIONS

This application claims priority to U.S. Provisional Application No. 61/763,342 filed 11 Feb. 2013, whose entire contents are incorporated herein by reference.

### FIELD

The currently disclosed subject matter pertains in general to the grading of gemstones, and more particularly to the producing of gemstone grading scales.

### BACKGROUND

Among known methods and systems for diamond grading the most popular in the trade are those of the Gemological Institute of America (GIA) used for grading the four ‘C’s (4Cs) including diamond carat, cut, color and clarity.

In addition to the above 4Cs grading, a variety of attempts have been made to grade gemstones based on their parameters other than the 4Cs, relating to the light performance and beauty of gemstones, and examples of these are disclosed in U.S. Pat. No. 6,786,733; U.S. Pat. No. 7,414,709; and U.S. Published Patent Application No. 2002/0052170.

### SUMMARY

One aspect of the currently disclosed subject matter relates to a method of generating a single grading scale for gemstones using a computer comprising a processor operatively coupled to a memory, the method comprising:
setting a plurality of grades characterizing the single grading scale from high to low, and setting an aimed statistic distribution of gemstones through the grades in said grading scale;
defining parameters of gemstones, based on which the grading is to be performed;
measuring values of each parameter for each gemstone in a statistically relevant sample of gemstones, thus giving rise to a plurality of the measured values for each parameter;
processing the plurality of the measured values by deriving from the measured values unique groups relating to all the parameters;
generating clusters of the unique groups to define respective grades of the plurality of grades so that a distribution of the gemstones in the statistically relevant sample in accordance with the generated clusters corresponds to the aimed statistic distribution in the single grading scale; and
storing in the memory a data structure comprising the generated clusters associated with the respective grades, the stored data structure to be used as the single grading scale for grading a gemstone characterized by specific values of the defined parameters.

The above single scale can be used to grade any diamond as a whole based on its light performance, e.g. based on such parameters as brilliance, fire, scintillation, light symmetry, and can enable anyone to compare diamonds using one scale of single final-grades relating to light performance, arranged in a hierarchical sequence to represent stone quality in defined and sequential steps between two extremes of maximum and minimum.

The fact that the above method of producing a single grading scale is based on the use of the aimed statistic distribution of gemstones through the grades and on measurements performed in the statistically relevant sample and processed in accordance with the aimed statistic distribution, ensures that the resulting single grading scale accurately and consistently reflects gemstone value based on the actually existing gemstone distribution in the trade. Namely, a gemstone which receives a high grading according to the above single grading scale, will statistically also receive similarly high grading according to the grading systems promoted today by AGS and GIA for the 4C's. The added value is the simplicity of the scale. Instead of having to consider and weigh a multitude of grades for brilliance, fire, scintillation and light symmetry, a customer now has the valuation of a gemstone at a glance, reflected in one simple term out of a single scale of a relatively low number of quality steps, reflected in distinct steps from lowest to highest.

The clusters in the above method can comprise unique groups of unique ranges of the measured values.

The measuring can be done based on images taken under lighting conditions suitable for revealing the specific parameter being measured. Such images can be images of real gemstones taken under real lighting conditions, or they can be virtual images of virtual, modeled gemstones, modeled under virtual lighting conditions, produced by optical Computer Aided Engineering methods/devices, such as ray tracing methods/systems and the like.

In addition establishing at least one of the statistically relevant sample or the aimed distribution can be based on the use of the 4C's grading method widely accepted in the trade. Since the trade heavily relies on this method, basing the definition of the statistically relevant sample on it will lead to a high reliability in relation to the correlation of the sample to the totality of gemstones existing in the trade. However, there are other possibilities for ascertaining such a reliable correlation, such as measuring diamonds that belongs to the same carat size range (for example diamonds that are from 0.50 carat to 0.60 carat) and are sorted by the owner in different pricing. The light performance of the higher priced diamonds should be better than these of the lower priced diamonds.

The method can comprise setting for each of the defined parameters a scale of sub-grades from high to low. There is a variety of strategies available for such setting of a scale. One example is to set the same sub-grade scale for all parameters of all the measured gemstones. Such sub-grades can be named, for better support in the trade, with same names as used in existing grading methods, such as Excellent, Very Good, Good, Fair and Poor, or naming new terms to distinguish from the existing grading methods such as Ultimate, Very High, High, Standard and Low. Another example is to set individual sub-grade scales per parameter.

The method can include assigning to each sub-grade of each defined parameter a unique range of its measured values. The measured values for each parameter can be normalized in a common scale for all the parameters.

The generating of clusters of unique groups derived from the measured values, relating to all the defined parameters, to define respective grades of the plurality of grades so that a distribution of the gemstones in the statistically relevant sample in accordance with the generated clusters corresponds to the aimed statistic distribution in the single grading scale, can comprise:
generating, by the processor, the unique groups of the unique ranges, each unique group constituted by one unique range for each of the defined parameters;
assigning, by the processor, for each unique group of the unique ranges a respective rate;
clustering, by the processor, the unique groups in accordance with the assigned rates.

The measuring of values of each parameter for each gemstone in a statistically relevant sample of gemstones can include obtaining the measured values, for example, from any one or more of the following:
directly or indirectly measuring the values in real stones by the same system that performs processing the plurality of the measured values, by deriving from the measured values unique groups relating to all the parameters;
acquisition and subsequent analysis of images of real stones recorded by an entity other than the above system, to derive the values therefrom;
obtaining numerical data on the light performance of real stones and subsequent assignment of the values based on such numerical data;
modeling real stones and subsequently performing computer simulations based thereon to obtain a virtual light return, and corresponding assignment of the values;
using cross-correlation charts that assign the values to real stones based on other, optical or non-optical data correlated with light performance parameters obtained previously for other stones;

The method can further include generating the unique groups of the unique ranges in accordance with an aimed statistic distribution of gemstones through the sub-grades in the single scale of sub-grades for each of the defined parameters.

When generating the clusters, the method can further include comparing, by the processor, the distribution in the statistically relevant sample of gemstones in accordance with the generated clusters with the aimed statistic distribution, and if the aimed distribution is not reached, further performing re-defining unique ranges or re-clustering unique groups for at least two grades, in order to bring the obtained distribution into conformity with the aimed distribution.

The re-defining unique ranges can be performed by shifting their borderline between at least two unique ranges of the parameters values. The re-clustering unique groups can be performed by re-assigning to a new final-grade at least one unique group previously assigned to a previous final-grade, the new and the previous final-grades being neighboring final-grades.

In accordance with another aspect of the presently disclosed subject matter, there is further provided a method of grading gemstones comprising:
providing a single grading scale wherein each single grade in the scale is associated with unique groups of unique value ranges of the parameters of gemstones in a statistically relevant sample of gemstones, the unique groups being established at least based on an aimed statistic distribution of gemstones through the grades in the grading scale and, optionally, a sub-grades scale wherein each value range corresponding to a sub-grade in the sub-grade scale for each parameter;
measuring the selected parameters of a gemstone; and
determining a single grade based on the measurement and the single grading scale, and optionally, determining a sub-grade for each parameter in its corresponding sub-grade scale.

With respect to this aspect, measuring can further include obtaining the measured values from any one or more of the following:
directly or indirectly measuring the values in real stones by the same system that performs processing the plurality of the measured values by deriving from the measured values unique groups relating to all the parameters;
acquisition and subsequent analysis of images of real stones recorded by an entity other than the above system, to derive the values therefrom;
obtaining numerical data on the light performance of real stones and subsequent assignment of the values based on such numerical data;
modeling real stones and subsequently performing computer simulations based thereon to obtain a virtual light return, and corresponding assignment of the values;
using cross-correlation charts that assign the values to real stones based on other, optical or non-optical data correlated with such light performance parameters obtained previously for other stones;

In a still further aspect, there is provided a single grading scale recorded on a non-transitory computer-readable medium and producible by a method using a computer comprising a processor operatively coupled to a memory, the method comprising:
setting a plurality of grades characterizing the single grading scale from high to low, and setting an aimed statistic distribution of gemstones through the grades in said grading scale;
defining parameters of gemstones, based on which the grading is to be performed;
measuring values of each parameter for each gemstone in a statistically relevant sample of gemstones, thus giving rise to a plurality of the measured values for each parameter;
processing the plurality of the measured values by deriving from the measured values unique groups relating to all the parameters;
generating clusters of the unique groups to define respective grades of the plurality of grades so that a distribution of the gemstones in the statistically relevant sample in accordance with the generated clusters corresponds to the aimed statistic distribution in the single grading scale; and
storing in the memory a data structure comprising the generated clusters associated with the respective grades, the stored data structure to be used as the single grading scale for grading a gemstone characterized by specific values of the defined parameters.

In a next aspect, there is provided a single grading scale recorded on a non-transitory computer-readable medium and capable of being used for grading a gemstone based on pre-defined parameters thereof, wherein each single grade in the scale is associated with unique groups of unique value ranges of the parameters of gemstones in a statistically relevant sample of gemstones, the unique groups being established at least based on an aimed statistic distribution of gemstones through the grades in the grading scale.

The method by which the grading scale of this aspect is producible can further include establishing the unique groups also based on an aimed statistic distribution of gemstones for all value ranges of each parameter.

In a further aspect, there is presented a single grading scale recorded on a non-transitory computer-readable medium and capable of being used for grading a gemstone based on pre-defined parameters thereof, wherein each single grade in the scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in the grading scale.

This aspect can further include the correspondence between each value range and each corresponding sub-grade based on an aimed statistic distribution of the gemstones in the single sub-grade scale for each parameter.

In a still further aspect, there is presented a single grading scale for gemstones defined by the tables in enclosed FIGS. 4 and 5 and recorded on a non-transitory computer-readable medium.

In a still further aspect, there is provided a system capable of generating a single grading scale for gemstones based on values of predefined parameters thereof, the system comprising:
a first interface configured to obtain values of each of the parameters measured for each gemstone in a statistically relevant sample of gemstones, thus giving rise to a plurality of the measured values;
a second interface configured to obtain a plurality of grades ordered from high to low and defined as characterizing the single grading scale; an aimed statistic distribution of gemstones through the grades in the grading scale; parameters of gemstones, based on which the grading is to be performed;
a processor operatively coupled to the first interface and the second interface and configured to process the plurality of the measured values to generate clusters of unique groups associated with respective grades so that a distribution of the gemstones in the statistically relevant sample in accordance with the generated clusters corresponds to the aimed statistic distribution in the single grading scale; and
a memory operatively coupled to the processor, to the first interface and to the second interface and configured to store a data structure comprising the generated clusters associated with the respective grades, the stored data structure to be used as the single grading scale for grading a gemstone characterized by the defined parameters.

This aspect can further include one or more of the following features:
the parameters comprising at least one of brilliance, fire, scintillation and light symmetry;
the clusters comprising unique groups of unique ranges of said measured values;
the processor further being configured to:
   assign to each sub-grade of each defined parameter a unique range of said measured values corresponding to the respective parameter;
   generate said clusters by including the operation of generating the unique groups of the unique ranges, each unique group constituted by one unique range for each of the defined parameter;
   assign for each unique group of the unique ranges a respective rate;
   cluster the unique groups in accordance with the assigned rates.
the processor being further configured for setting for each of the defined parameters a scale of sub-grades, which is constituted by setting a single scale of sub-grades for all the defined parameters;
the processor being further configured for generating the unique groups of the unique ranges in accordance with an aimed statistic distribution of gemstones through the sub-grades in said single scale of sub-grades for each of the defined parameters;
the processor further being configured for generating the clusters by the operation of comparing the distribution of the gemstones in said statistically relevant sample in accordance with the generated clusters with the aimed statistic distribution, and if the aimed distribution is not reached, further including the operation of performing at least one of the following steps in order to bring the former distribution into conformity with the latter distribution: re-defining unique ranges or re-clustering unique groups for at least two grades;
the processor being further configured to perform the step of re-clustering unique groups by re-assigning to a new final-grade at least one unique group previously assigned to a previous final-grade, said new and said previous final-grades being neighboring final-grades;
said first interface being configured for obtaining said values based on images taken under lighting conditions suitable for revealing the specific parameter being measured;
the processor further being configured for establishing at least one of said statistically relevant sample or said aimed distribution based on the use of the 4C's grading system.

In a still further aspect, there is provided a system for grading gemstones, the system comprising:
an interface configured to obtain the values of predefined parameters of a gemstone to be graded;
a memory storing a single grading scale recorded on a non-transitory computer-readable medium and capable of grading a gemstone based on pre-defined parameters thereof, wherein each single grade in the scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in the grading scale; and
a processor operatively coupled to the interface and the memory and configured to grade the gemstone in accordance with the unique groups associated with the grades in the single scale.

The system in accordance with this aspect can further include at least one of the following:
a stage for mounting a gemstone and one or more measuring devices operatively coupled to the interface, the device being configured for measuring the parameters of the gemstone to provide the values;
an interface configured to produce a gemstone grading report in accordance with the grading provided by the processor.

In accordance with a further aspect, there is provided a system comprising a computer-readable non-transitory storage medium containing a computer-readable data and instructions for producing a single grading scale of light performance in accordance with any of the aspects hereinabove; the non-transitory storage medium, the computer-readable data and the instructions having a form that can be integrated into any other system, which is configured for executing the method according to any of the aspects of the subject matter of the present application.

In accordance with a still further aspect of the presently disclosed subject matter, there is provided a method for grading a diamond by a system, based on
parameters based on which the grading is to be performed;
quantity of sub-grades of the parameters;
borderlines that dissect the values of each parameter to form sub-grades;
combinations of parameters and sub-grades based on counting the same sub-grades;
quantity of final-grades of the single grading scale;
assignment of each combination to a final-grade;
   the method including the performance of the following steps by said system: measuring said parameters; assigning for each parameter its sub-grade using said borderlines; determining the combination of sub-grades for all the parameters, and assigning to said combination a final-grade in the single grading scale.

According to a still further aspect according to the presently disclosed subject matter there is provided a system configured for grading diamonds based on their light performance parameters, which comprises:

a stage for mounting the gemstone;
a means of generating light environments to provide conditions needed for measuring said parameters;
a measuring device for receiving the light return from the diamond in multiple light environments and for communicating the measured signal to a computer;
the computer having:
a memory with and/or ability to access via internet to:
a quantity of sub-grades of the parameters;
borderlines that dissect the values of each parameter to sub-grades;
combinations of parameters and sub-grades based on counting the same sub-grades;
a quantity of final-grades of the single grading scale;
assignment of each combination to a final-grade;
   communication capability for receiving the measured signals from the measuring device;
   an algorithm to determine values of each parameter from the measured signals, to determine the sub-grade of each parameter based on said borderlines and to assign to the combination of parameters and sub-grades a final-grade in a single grading scale;
   an interface or communication port for communicating the results.

In a still further aspect, there is presented a gemstone grading report recorded on a non-transitory computer-readable medium, and comprising indication of a grade for the gemstone in a single grading scale based on pre-defined parameters thereof, wherein each single grade in the scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in the grading scale.

In this aspect, the grading report can further include:
a sub-grade for each parameter in the single sub-grade scale;
data stored in and extractable from a database located on a computer, which is accessible locally or globally via any of the known methods in the art.

In accordance with a still further aspect of the invention, there is provided a report for a measured diamond, including, for each parameter

its sub-grade and the final grade in the single grading scale established according to the method described hereinabove.

The above presented aspects thus provide methods, systems and reports for grading gemstones by one single grading scale, and, optionally, by a plurality of sub-grades of a sub-grade scale for a plurality of properties of such gemstones.

It needs to be noted that any of the above aspects can include as parameters the parameters of brilliance, fire, scintillation, light symmetry. Furthermore, it is clear to the skilled person that any other parameters can be defined to be included in the above total grading scale.

The hereinbefore described aspects associated with the single grading scale as described above offer a novel approach to grading gemstones based on transparent, repeatable procedures and conditions, and resulting in a simple, convenient single grade per gemstone.

By this token, the single grading scale can fulfill a need for simplified communication on a common basis, without thereby compromising on depth of considerations regarding the different factors that influence the evaluation of gemstones.

### BRIEF DESCRIPTION OF THE DRAWINGS

FIG. 1 shows a block diagram, which schematically visualizes different stages and steps of a method of producing a single grading scale for diamonds based on a number of their light performance parameters, according to one example of presently disclosed subject matter;

FIG. 2 illustrates one example of a sub-grade scale, which can be used in the method of FIGS. 1 and 2, for grading each light performance parameter;

FIG. 3 illustrates how diamonds can be characterized by grading their light performance parameters using the sub-grade scale of FIG. 2;

FIG. 4 is a table presenting a list of unique groups of sub-grades and illustrating their weighting and rating;

FIG. 5 illustrates clustering the unique groups rated in the table of FIG. 4 into final grades;

FIG. 6 illustrates a system for grading diamonds using the single grading scale produced by the method illustrated in FIG. 1;

FIG. 7 illustrates one example of a report that can be produced by the system of FIG. 6 in accordance with the single grading scale produced by the method of FIG. 1; and

FIG. 8 illustrates, in a block diagram, steps performed during one example of an actual process of grading a gemstone using the single grading scale produced by the method illustrated in FIG. 1.

### DETAILED DESCRIPTION

In the following detailed description, numerous specific details are set forth in order to provide a thorough understanding of the invention. However, it will be understood by those skilled in the art that the presently described subject matter can be practiced without these specific details. In other instances, well-known methods, procedures, components and circuits have not been described in detail so as not to obscure the description.

Unless specifically stated otherwise, as apparent from the following discussions, it is appreciated that throughout the specification discussions utilizing terms such as “processing”, “computing”, “calculating”, “determining”, “generating”, “configuring” or the like, refer to the action and/or processes of a computer that manipulate and/or transform data into other data, the data represented as physical, such as electronic, quantities and/or the data representing the physical objects. The term “computer” should be expansively construed to cover any kind of electronic device with data processing capabilities.

The operations in accordance with the teachings herein can be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

It is to be understood that the term “non-transitory” is used herein to exclude transitory, propagating signals, but to include, otherwise, any volatile or non-volatile computer memory technology suitable to the presently disclosed subject matter.

As an example throughout this detailed description, the gemstones graded are diamonds, and the terms “gemstone” and “diamond” are understood to be interchangeable. However, it is clear to the skilled person, that any other type of gemstone can be graded by the herein disclosed methods and systems.

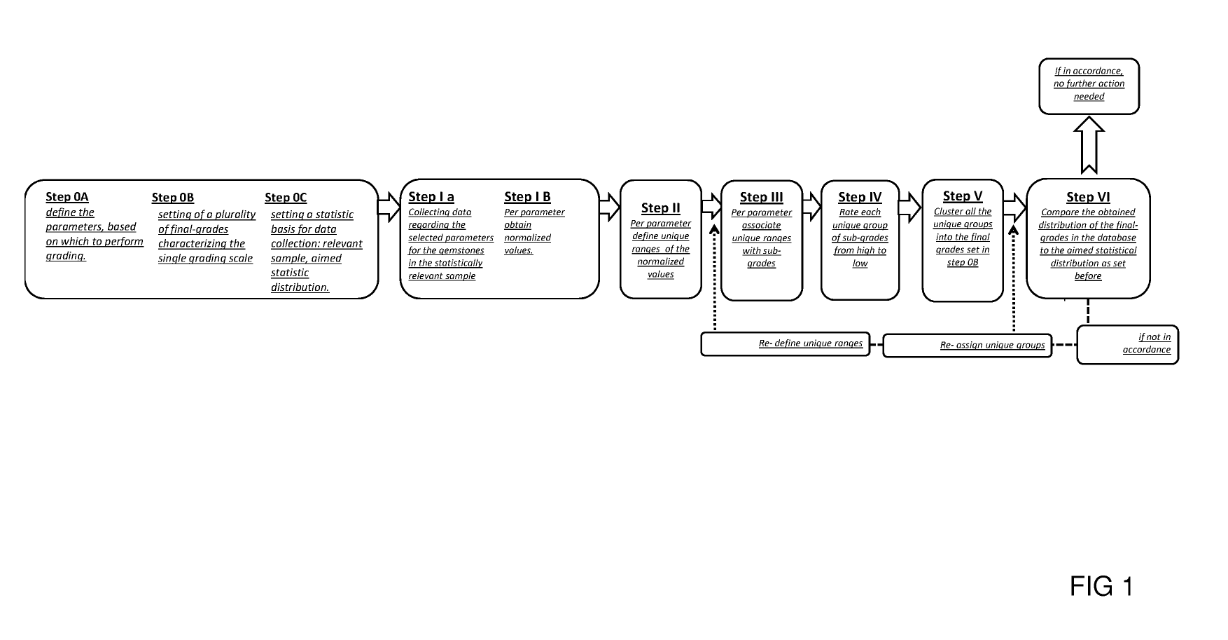

Bearing the above in mind, attention is first drawn to FIG. 1, in which a combined block diagram is presented, schematically illustrating a non-limiting example of different stages of a method of producing a single grading scale for light performance grading of diamonds, to be performed using a computer with a memory and/or access via internet that contains all the information required for performing the grading method and capabilities needed for grading, i.e. a computer comprising a processor operatively coupled to a non-transitory storage medium, in accordance with one embodiment of the presently disclosed subject matter.

As presented in FIG. 1, the described method can generally be divided into the following stages:
setting scale's basic definitions, including selecting parameters, based on which diamonds are to be graded by the single grading scale (step 0A); setting a plurality of final grades characterizing the single grading scale (step 0B), and setting a statistic basis for data collection (step 0C);
collecting data regarding the selected parameters from a statistically relevant sample of diamonds (steps IA and IB), and
analyzing and processing the collected data using a computer to produce the single grading scale (steps II to VI).

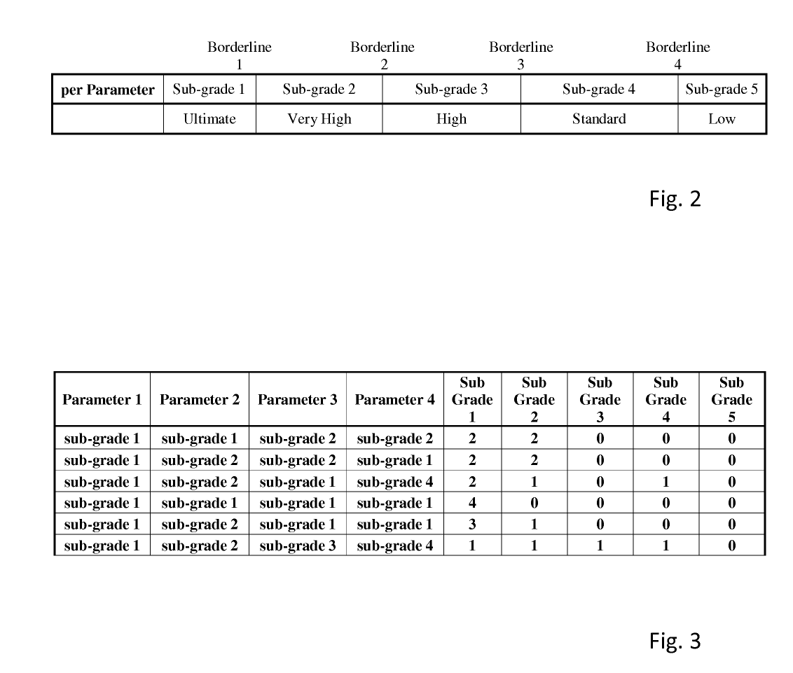

FIGS. 2 to 5 illustrate the results of different steps of final stage of the method illustrated by FIG. 1.

As illustrated in step 0A in FIG. 1, the first thing in the described method is to define the parameters of diamonds, based on which the single grading scale of their light performance is to be produced.

In the described example, these parameters can be four typical parameters of the diamond: brilliance, fire, sparkle (also known as scintillation) and light symmetry.

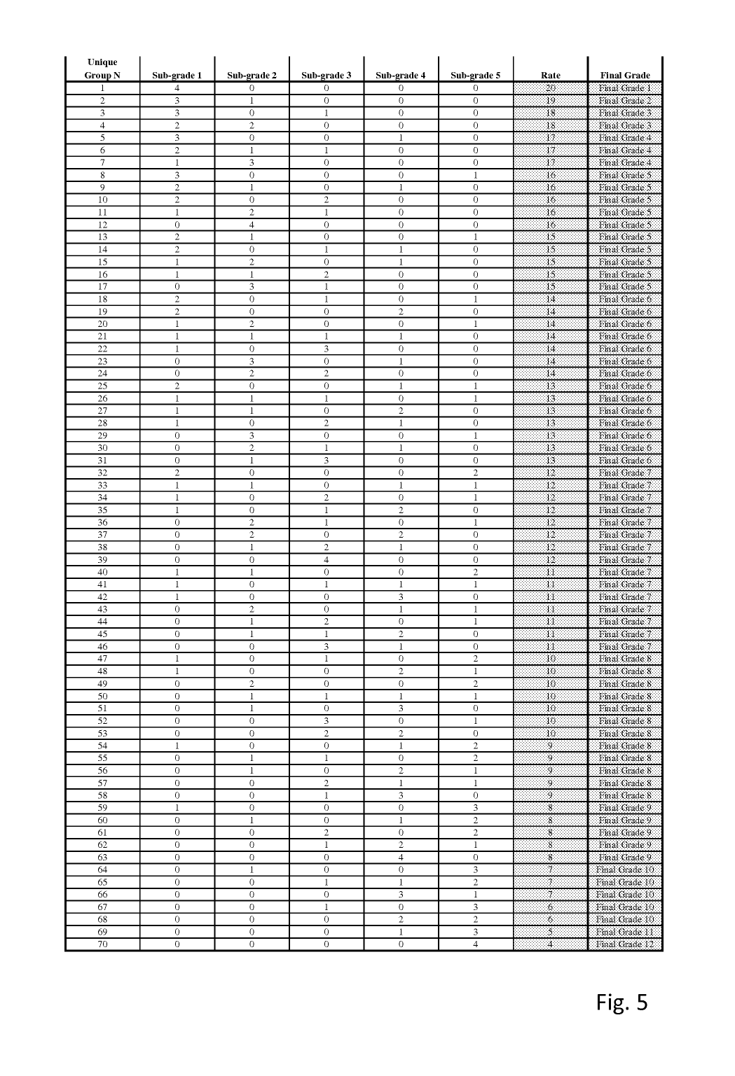

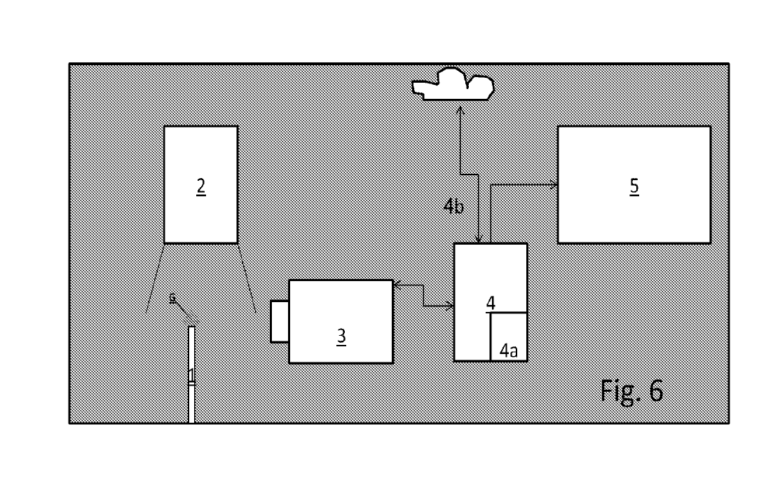

In step 0B in FIG. 1, plurality N of final grades characterizing the single grading scale from the highest N_{high} to the lowest N_{low} grade, are set. The number of final grades N between the highest and the lowest grades can be any number acceptable in grading diamonds. In the example illustrated in FIG. 5, to which reference will be made below with more detailed explanations, the number of final grades is twelve.

In step 0C in FIG. 1, a statistic basis for data collection is set including the definition of a statistically relevant sample of diamonds and setting an aimed statistic distribution of diamonds through the final grades set for the single grading scale.

The statistically relevant sample of gemstones is determined so as to ensure that data to be collected therefrom covers most kinds of diamonds that are known in the trade.

In the present example, the statistically relevant sample has been determined, using the fact that all diamonds in the trade can be graded by their 4Cs values, that values of each of the 4Cs can be grouped into groups (for example, the color grades D E F can be grouped into one group), and that segments can be formed by the combination of such different groups.

Below is an example of a possible segmentation of the 4Cs used in the present embodiment, based on their grades according to the GIA scale.

The carat grouping depends on the grader's decision since carat values are a continuum from 0.001 to huge size of 300.00 carats. The grader will, for example, group them in groups such as: 0 to 0.24; 0.25 to 0.49; 0.50 to 0.99; 1.00 to 1.49; 1.50 to 1.99; 2.00 to 3.99; 4.00 and above, to amount to a total of 7 segments.

Clarity grades are: IF; VVS1; VVS2; VS1; VS2; SI1; SI2; SI3; I1; I2; I3—a total of 11 groups.

Color Grade: D to F; G to I; J to L; M and above—a total of 4 groups

Cut Grade: Excellent; Very Good; Good; Fair; Poor—a total of 5 grades, which in this case form one group per grade.

A segment in the database can thus be a combination of different 4Cs groups. An example of a segment is:
Carat weight from 0.25 carats to 0.49 carats;
Clarity Grade using the GIA scale IF to VS2;
Color Grade using the GIA scale of color D to F;
Cut Grade using the GIA scale of Excellent.

It is clear to the skilled person that there are many more ways of segmentation of the 4C's, and the hereinabove described segmentation is but one example of them.

The total quantity of segments according to the above example is thus the multiplication of the quantity of segments in each C for all the Cs, which is 7×11×4×5, i.e. 1,540 segments.

To ensure that a sample of diamonds will be in fact statistically relevant, each segment should include substantial quantity of diamonds, from which data regarding their parameters will be collected to have enough data to enable statistics analysis. Such a substantial quantity for each segment can be between 16 to 100 stones, more particularly, between 17 and 50, even more adequately between 18 and 30; in an exemplary case, a number of 20 stones per segment has proven to be sufficient. With each segment including 20 diamonds, there the statistically relevant sample will include 30,800 diamonds.

The aimed statistic distribution can be set based on obtaining data that represents the trade. This can be done by addressing multiple players in the trade. This includes large wholesalers, diamond manufacturers of variety of goods, and other players in the trade.

Additional input to the segmentation of the trade is by analyzing trade websites and determining the statistics of each diamond segment, e.g. where this data is open to the public.

The segments should not have even size distribution since the distribution in the trade itself is not even. The statistical distribution of each segment should be defined as well. This is used to define how many diamonds are needed from each segment to meet the data collection goal for producing the statistically relevant sample.

Each one of the players describes the typical goods that he manufactures or sells and the distribution of his goods. For example, a manufacturer that cuts diamonds that cover a certain size range (0.25 ct. to 2.50 ct.); certain clarity range (IF to VS2) and color range (D to J). In most cases internal sorting of superior and inferior goods is performed. In these cases the internal sorting prices are set so that superior goods are priced higher than inferior goods. The difference of pricing is later used to determine if the method reflects that better (higher priced) goods statistically score higher final-grade than goods with lower pricing.

This enables mapping the gemstones to the segments that were set as goals for data collection to produce the statistically relevant sample, and determining intended statistical quantity distribution of diamonds between the final-grades in the single grading scale in accordance therewith. For example, the expectation is that for high clarity diamonds (IF to VVS), with high color (D to F) and for high cut grade (Excellent), the grades in the single grading scale will be statistically higher than for diamonds with low clarity (I) low color (M and above) and low cut grade (Poor).

It should be clear to the skilled person that any number of final grades, with any names or indications of quality can be chosen, and that the aimed statistical distribution can depend on a wide variety of criteria. It is further clear to the skilled person that such a grading scale will depend on the parameters defined, and can, at this stage of the process, be a first preliminary choice, to later be adjusted.

In step IA in FIG. 1, data regarding the selected parameters for the gemstones in the statistically relevant sample is collected either by measuring these parameters, e.g. by scanning each gemstone in the sample by a suitable system (see a description of one example of such system presented below after the description of the present method), or by otherwise obtaining measured or simulated values for the respective parameters

In step IB in FIG. 1, the values of the parameters obtained in step IA are normalized to bring them to a single scale, for example from 0 to 100. In this respect it should be obvious to a skilled person, that any other scales of normalization can be used.

It should be noted that, in alternative examples not discussed, the measured values can be not normalized.

In step II of FIG. 1, the normalized values of each of the selected parameters are then segmented into unique ranges of values.

If desired, it can be verified that the segmentation of the light performance parameters is correlated with the 4Cs segmentation. To this end, for each diamond in the statistically relevant sample, in addition to its selected parameter, whose values are obtained in step IA, its 4C's are recorded: its carat size, its clarity grading, its color and its cut grade and the segmentations are compared. An example of such verification is as follows:
comparing 2 segments of the parameters' values, for which there is an expectation that the parameters' values for one segment will be higher than the other; for example, the expectation is that for high clarity diamonds (IF to VVS), with high color (D to F) and for high cut grade (Excellent), the values of the parameters should be statistically higher than diamonds with low clarity (I) low color (M and above) and low cut grade (Poor); or for example diamonds with the same color and clarity segments but differ by cut grade, the expectation that the value of parameters of the better cut grade will be statistiacally higher than these of worst cut grade.
if the statistics is according to the expectation/intentions, then the validity of the measured parameters is established.

It is clear to a skilled person that many other strategies of verification, with different criteria as to what is to be expected/intended, are feasible; in this respect, the above example is by no means to be seen as limiting or exclusive.

In step III in FIG. 1, the unique ranges of values of the selected parameters are associated with sub-grades, where the sub-grades form one single sub-grade scale for all the parameters, i.e. all the parameters are divided to have the same quantity of sub-grades.

The sub-grades can have specific descriptive names. In particular, the sub-grades can be named to support their use in the trade, the idea being of going from higher value to lower value.

One example of a quantity of sub-grades can be five with their names—Ultimate, Very High, High, Standard and Low, as illustrated in FIG. 2.

It should be clear to a skilled person that any reasonable quantity that is more than 2 can be assigned, depending on the goal of the grading scale, and that any other set of names or descriptors will do.

Each parameter is divided to sub-grades based on setting borderlines so that all values which are below a higher borderline and above a lower borderline have the same sub-grade.

In the example of FIG. 2, all values that are lower than borderline 1 and higher than borderline 2 belong to sub-grade 2.

The association of the unique ranges of values of the selected parameters with sub-grades should be based on a required statistics distribution of each sub-grade determined for each parameter. For example, it can be decided that the size of the top sub-grade (Ultimate) is set to 15%, the second sub-grade to 20%, the third sub-grade to 30%, the fourth sub-grade to 20%, and the lower sub-grade to 15%.

The statistics is also validated for typical segments of sub-grades of each parameter. For example, for the high quality segment, the distribution should be for the top sub-grade 30% and for the lowest sub-grade 5%, and for the low quality segment the distribution for the top sub-grade 10% and the lowest sub-grade should be 30%.

At this point, each diamond in the database has for each of the parameters a sub-grade, and is thus characterized by a combination of four sub-grades (one—for each of the four parameters), as illustrated in FIG. 3, where examples of six diamonds are presented.

Using the above names of the sub-grades, the diamond represented by third line in FIG. 3, has the following sub-grades for the four selected parameters:

| | |
|---|---|
| Brilliance | Ultimate |
| Fire | Very High |
| Sparkle | Ultimate |
| Symmetry | Standard |

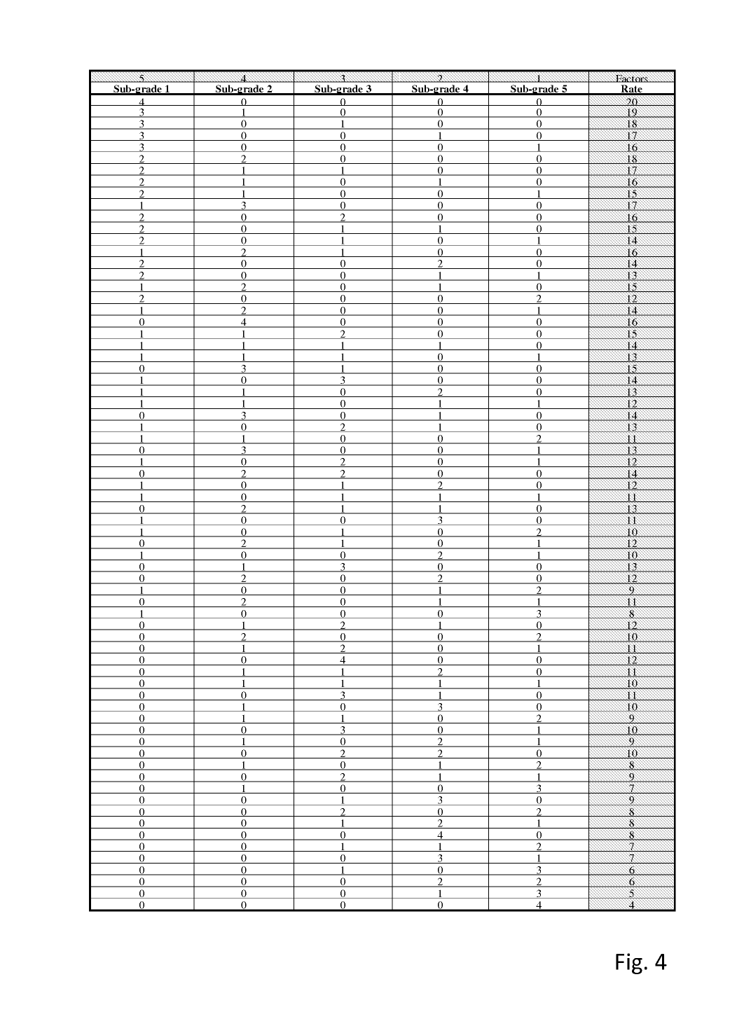

This diamond is represented in FIG. 4 as having in total the following sub-grades: 2 Ultimate, 1 Very High and 1 Standard.

In another example, the diamond represented by line 5 in FIG. 3, has the following sub-grades for the four selected parameters:

| | |
|---|---|
| Brilliance | Ultimate |
| Fire | Very High |
| Sparkle | Ultimate |
| Symmetry | Ultimate |

This diamond is represented in FIG. 4 as having in total the following sub-grades: 3 Ultimate and 1 Very High.

Still another diamond may have 4 Ultimate and so on.

Since in FIG. 3 each of the 4 parameters has 5 sub-grades, there are in FIG. 4 altogether 70 possible combinations or unique groups of the total sub-grade numbers, which diamonds can have. If there were three parameters and five sub-grades, then there would be 35 unique groups.

In step IV, each unique group is rated from high to low. The highest rate is assigned for the unique group with all the parameters scoring the top sub-grade and the lowest rate is assigned for the unique group with all parameters scoring the lowest sub-grade.

One method of assigning rates can be setting a weighting factor to each sub-grade and examining the total score. For example, in the rating illustrated in FIG. 4, a weighting factor of 1 is given to the lowest sub-grade, and then for the next level a weighting factor of 2 (1; 2; 3; 4; 5 etc.) is given, the total rate being the multiplication of the weighting factor by the quantity of score in each sub-grade.

More particularly, with the 4 parameters and 5 sub-grades, the weighting factor of 5 is assigned to Ultimate sub-grades, the weighting factor of 4 is assigned to Very High sub-grades, the weighting factor of 3 is assigned to the High sub-grades, the weighting factor of 2 is assigned to the Standard sub-grades and the weighting factor of 1 is assigned to the Low sub-grades. In this case, diamonds with 4 parameters having the top sub-grades (4 Ultimate—as in the first line of the table in FIG. 4), will have the rate calculated by the multiplication of 5 by 4, which is 20. Where out of four parameters, there are 2 top sub-grades (Ultimate), 1 third sub-grade (High) and 1 the lowest sub-grade (Low), the rate will be 5×2+3×1+1×1=14 (as in the twelve's line of the table in FIG. 4).

To facilitate further steps, in FIG. 4 the unique groups have been sorted in a sequence from the highest to the lowest rate.

To rate all the unique groups other methods can be used.

In step V, all the unique groups are clustered into the final grades set in step 0B above.

The clustering is performed by assigning the same final-grade to unique groups with similar rates, with the result that sequential ranges of one or more rates will be assigned to one grade. At the end of the process of assigning unique groups to final-grades, every unique group is assigned to one final-grade in the single grading scale. This allows the rates to show a distribution across the grades, when there are more rates than grades.

In particular, with reference to FIG. 4, the 70 unique groups are clustered into 12 final-grades (see the rightmost column), by assigning to each one of the 12 final-grades, such a number of unique groups as to meet the aimed statistical distribution as discussed hereinabove.

Another method of clustering is looking for unique groups with equivalent and then similar performance. One example of equivalence is as follows: a unique group with 2 top sub-grades (Ultimate) and 2 lowest sub-grades (Low) is equivalent to a unique group, where one of the two high sub-grades is downgraded (Ultimate to Very High) and one of the two low sub-grades is upgraded (Low to Standard), resulting in the unique group with 1 top sub-grade (Ultimate), 1 second sub-grade (Very High), 1 forth sub-grade (Standard) and 1 lowest sub-grade (Low). One example of similar performance is as follows: a unique group with 3 top sub-grades (Ultimate) and 1 forth sub-grade (Standard) is similar, but superior, to a unique group with 3 top sub-grades (Ultimate) and 1 lowest sub-grade (Low).

The above methods can be combined in any desired combination.

In step VI, the obtained distribution of the final-grades in the database is compared to the aimed statistical distribution as set before.

If the actual distribution doesn't meet the required distribution, then, in accordance with the above described methods, at least one of the following actions is performed:
at least one unique group from one final-grade is re-assigned to a neighboring final-grade; this is done by choosing from the unique groups in the specific final-grade
   at least one unique group with the highest rate in that grade and upgrading this unique group to the neighboring higher final-grade; and/or
   at least one unique group with the lowest rate in the grade and downgrading it to neighboring lower final-grade; during this process, groups that have equivalent performance are moved all at once, and only groups that are not similar to one another are allowed to move separately;
re-defining unique ranges by shifting at least one borderline between at least two unique ranges.

The process is performed until the actual distribution of final-grades is very close (within 0.5%) to the aimed statistical distribution of the database, and each one of the unique groups is assigned to a final-grade in the single grading scale.

With reference to FIG. 5, the final single grading scale is presented (rightmost column) in association with unique groups of the corresponding sub-grades, obtained as a result of steps V and VI, in which care has been taken that the top final-grade should have, for example, 8% of the diamonds from the statistically relevant sample, the next grade should have 10% and so on.

To summarize the above, the following information defines the grading scale produced as described above:
The definitions of the parameters (in the specific example illustrated in the drawings—4 parameters);
The quantity of sub-grades of the parameters (in the above specific example—5 sub-grades);
The borderlines that dissect the values of each parameter to sub-grades (in the specific example—4 borderlines to generate the 5 sub-grades);
The unique groups of parameters and sub-grades based on counting the same sub-grades (in the above specific example—70);
The quantity of final-grades of the single grading scale (in the above specific example—12);
Assignment of each unique group to one final-grade.

The scale defined by the above information is thus recorded on a non-transitory computer-readable medium, e.g. computer memory, which further includes instructions on its use for grading diamonds.

The process of grading a diamond using the single grading scale as described above will thus be performed using a computer as follows:

(i) The selected light performance parameters of the diamond are obtained, for example, by their measurement in the diamond; thus, for example, the diamond can have:
Brilliance 65
Fire 85
Sparkle 72
Symmetry 82
   (ii) The computer will then:
assign to the value of each parameter its sub-grade using the borderlines of the sub-grade scale; with the borderlines being as follows:

| | Borderline 1 | Borderline 2 | Borderline 3 | Borderline 4 |
|---|---|---|---|---|
| Brilliance | 80 | 60 | 40 | 20 |
| Fire | 90 | 72 | 55 | 35 |
| Sparkle | 85 | 75 | 50 | 15 |
| Symmetry | 90 | 70 | 40 | 30 |

the sub-grades assigned to each of the parameters will be: Brilliance sub-grade—2 (65 is lower than borderline 1 and higher than borderline 2); Fire sub-grade—2; Sparkle sub-grade—1; Symmetry sub-grade—2;
with the above sub-grades constituting the following unique group of sub-grades: 1—of sub-grade 1 and 3—of sub-grade 2, the computer will then assign to this group a final grade in the single grading scale; using the table of FIG. 5, this diamond will then be assigned the final-grade of 4.

The above grading method can be performed by a system which can have components existing in any conventional system, which can measure light performance parameters of diamonds and which has a computer provided with means implementing the grading method described above. This can, for example, be the system sold under the trade name Sarine Light™ or the system known under the trade name ISEE2™ or the one described in U.S. Pat. No. 8,116,552 B2, incorporated herein by reference.

Referring to FIG. 6, the system can generally comprise:
a) a stage 1 for mounting a gemstone G thereon;
b) an illumination arrangement 2 for generating different light environments to facilitate the conditions needed for the measuring of the parameters; this entails generating lighting conditions suitable for revealing the specific parameter being measured;
c) a measuring device 3 for receiving the light return from the diamond;
d) a computer 4 in communication with the measuring device 3 for receiving therefrom the measured signal, the computer having a memory 4a and/or an access via internet 4b that contains all the information required for performing the grading method as described above and capabilities needed for grading, which includes:
   an algorithm to determine values of each parameter from the measured signals;
   borderlines for each parameter to determine the sub-grade of each parameter; and
   the rules of assignment of each unique group of sub-grades to a final grade in the single grading scale;
e) an interface 5 or communication port for communicating the results such as, for example a report on the measured diamond.

The report can, for example, presents the sub-grade for each parameter and the final grade in the single grading scale, established according to the method described hereinabove.

The report can further include the 4C's of the diamond, a QR code to access the report in the Internet, images of the diamond as being taken during the process of measuring the parameters.

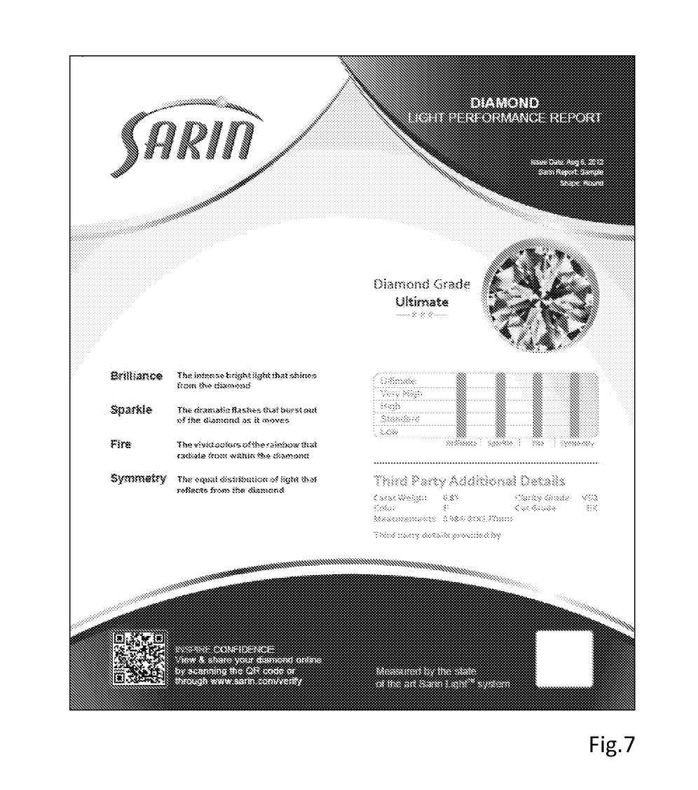

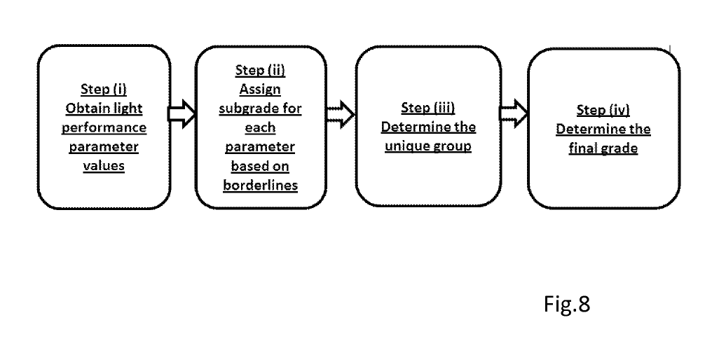

One example of the report is presented in FIG. 7.

In other words, a system capable of generating the single grading scale for gemstones based on values of predefined parameters thereof, which for example can be brilliance, fire, scintillation and light symmetry, can comprise:
a first interface configured to obtain values of each of said parameters measured for each gemstone in a statistically relevant sample of gemstones, thus giving rise to a plurality of the measured values;
a second interface configured to obtain a plurality of grades ordered from high to low and defined as characterizing the single grading scale; an aimed statistic distribution of gemstones through the grades in said grading scale; parameters of gemstones, based on which the grading is to be performed;
a processor operatively coupled to the first interface and the second interface and configured to process said plurality of the measured values to generate clusters of unique groups of unique value ranges associated with respective grades so that a distribution of the gemstones in said statistically relevant sample in accordance with the generated clusters, corresponds to said aimed statistic distribution in the single grading scale; and
a memory operatively coupled to the processor, to the first interface and to the second interface and configured to store a data structure comprising the generated clusters associated with the respective grades, the stored data structure to be used as the single grading scale for grading a gemstone characterized by said defined parameters.

In the above system, the clusters can comprise unique groups of unique ranges of said measured values.

The processor can further be configured to:

set for each of the defined parameters a scale of sub-grades from high to low and assign to each said sub-grade of each defined parameter one said unique value range of said measured values corresponding to the respective parameter;

generate said clusters by including the operation of generating the unique groups of the unique value ranges, each unique group constituted by one unique range for each of the defined parameter;

assign for each unique group of the unique ranges a respective rate;

cluster the unique groups in accordance with the assigned rates.

The processor can also be configured to set for each of the defined parameters a scale of sub-grades, and this scale can be a single scale of sub-grades for all the defined parameters.

The processor can also be configured for generating the unique groups of the unique ranges in accordance with an aimed statistic distribution of gemstones through the sub-grades in said single scale of sub-grades for each of the defined parameters.

The processor can be further configured for generating the clusters by including the operation of comparing the distribution of the gemstones in said statistically relevant sample in accordance with the generated clusters with the aimed statistic distribution, and if the aimed distribution is not reached, further including the operation of performing at least one of the following steps in order to bring the former distribution into conformity with the latter distribution: re-defining unique ranges or re-clustering unique groups for at least two grades.

The processor can be further configured for performing the step of re-clustering unique groups by re-assigning to a new final-grade at least one unique group previously assigned to a previous final-grade, said new and said previous final-grades being neighboring final-grades.

The first interface can be further configured to perform the obtaining of values based on images taken under lighting conditions suitable for revealing the specific parameter being measured.

The processor can be further configured for establishing at least one of said statistically relevant sample or said aimed statistical distribution based on the use of the 4C's grading system.

It is clear to the skilled person that the above description only serves as an exemplary case, without any limiting power to the described method, system and report to such example, and that the single grading scale and its sub-grade scale can be obtained in a large variety of ways without departing from the spirit of the above described process, system and report.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A method of generating a single grading scale for gemstones using a computer comprising a processor operatively coupled to a memory, said method comprising:
setting a plurality of grades characterizing the single grading scale from high to low, and setting an aimed statistic distribution of gemstones through the grades in said grading scale;
defining parameters of gemstones, based on which the grading is to be performed;
measuring values of each of said parameter for each gemstone in a statistically relevant sample of gemstones, thus giving rise to a plurality of the measured values for each parameter;
processing said plurality of the measured values by deriving from said measured values unique groups relating to all the parameters;
generating clusters of said unique groups to define respective grades of said plurality of grades so that a distribution of the gemstones in said statistically relevant sample in accordance with the generated clusters corresponds to said aimed statistic distribution in the single grading scale; and
storing in the memory a data structure comprising the generated clusters associated with the respective grades, the stored data structure to be used as the single grading scale for grading a gemstone characterized by specific values of said defined parameters.

2. The method of claim 1, wherein the clusters comprise unique groups of unique ranges of said measured values.

3. The method of claim 1, wherein said method further comprises:
setting for each of the defined parameters a scale of sub-grades from high to low;
assigning to each sub-grade of each defined parameter a unique range of said measured values corresponding to the respective parameter; and
wherein said generating clusters comprises:
generating, by the processor, the unique groups of the unique ranges, each unique group constituted by one unique range for each of the defined parameter;
assigning for each unique group of the unique ranges a respective rate;
clustering, by the processor, the unique groups in accordance with the assigned rates.

4. The method of claim 3, wherein setting for each of the defined parameters a scale of sub-grades is constituted by setting a single scale of sub-grades for all the defined parameters.

5. The method of claim 4, wherein generating the unique groups of the unique ranges is provided in accordance with an aimed statistic distribution of gemstones through the sub-grades in said single scale of sub-grades for each of the defined parameters.

6. The method of claim 3, wherein generating the clusters further comprises comparing, by the processor, the distribution in the statistically relevant sample of gemstones in accordance with the generated clusters with the aimed statistic distribution, and if the aimed distribution is not reached, further comprising the step of performing re-clustering unique groups for at least two grades.

7. The method of claim 6, wherein the step of re-clustering unique groups is performed by re-assigning to a new final-grade at least one unique group previously assigned to a previous final-grade, said new and said previous final-grades being neighboring final-grades.

8. The method of claim 1, wherein said measuring is done based on images taken under lighting conditions suitable for revealing the specific parameter being measured.

9. The method of claim 1, further including establishing at least one of said statistically relevant sample and/or said aimed distribution based on the use of the 4C's grading system.

10. The method of claim 1, wherein said parameters comprise at least one of brilliance, fire, scintillation and light symmetry.

11. A single grading scale producible by a method of using a computer and recorded on a computer memory, said method comprising:
setting a plurality of grades characterizing the single grading scale from high to low, and setting an aimed statistic distribution of gemstones through the grades in said grading scale;
defining parameters of gemstones, based on which the grading is to be performed;
measuring values of each of said parameter for each gemstone in a statistically relevant sample of gemstones, thus giving rise to a plurality of the measured values for each parameter;
processing said plurality of the measured values by deriving from said measured values unique groups relating to all the parameters;
generating clusters of said unique groups to define respective grades of said plurality of grades so that a distribution of the gemstones in said statistically relevant sample in accordance with the generated clusters corresponds to said aimed statistic distribution in the single grading scale; and
storing in the memory a data structure comprising the generated clusters associated with the respective grades, the stored data structure to be used as the single grading scale for grading a gemstone characterized by specific values of said defined parameters.

12. The single grading scale of claim 11, wherein said parameters comprise at least one of brilliance, fire, scintillation and light symmetry.

13. A single grading scale recorded on computer memory and capable of being used for grading a gemstone based on pre-defined parameters thereof, wherein each single grade in said scale is associated with unique groups of unique value ranges of said parameters of gemstones in a statistically relevant sample of gemstones, said unique groups being established at least based on an aimed statistic distribution of gemstones through the grades in said grading scale.

14. The single grading scale according to claim 13, wherein the unique groups are established also based on an aimed statistic distribution of gemstones for all value ranges of each parameter.

15. The single grading scale of claim 14, wherein said parameters comprise at least one of brilliance, fire, scintillation and light symmetry.

16. A single grading scale recorded on a computer memory and capable of being used for grading a gemstone based on pre-defined parameters thereof, wherein each single grade in said scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in said grading scale.

17. The single grading scale of claim 16, wherein said parameters comprise at least one of brilliance, fire, scintillation and light symmetry.

18. The single grading scale according to claim 16, wherein the correspondence between each value range and each corresponding sub-grade is established based on an aimed statistic distribution of the gemstones in said single sub-grade scale for each parameter.

19. A gemstone grading report recorded on a computer memory, and comprising indication of a grade for the gemstone in a single grading based on pre-defined parameters thereof, wherein each single grade in said scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in said grading scale.

20. The gemstone grading report of claim 19, further comprising a sub-grade for each parameter in said single sub-grade scale.

21. The gemstone grading report of claim 19, wherein said parameters comprise at least one of brilliance, fire, scintillation and light symmetry.
